(19) United States
(12) Patent Application Publication
(10) Pub. No.: US 2011/0104045 A1
(43) Pub. Date: May 5, 2011

(54) Hydrogen Production With CO2 Capture

(75) Inventor: Bhadra S. Grover, Suger Land, TX (US)

(73) Assignee: Air Liquide Process and Construction, Inc., Houston, TX (US)

(21) Appl. No.: 12/612,714

(22) Filed: Nov. 5, 2009

(51) Int. Cl. C01B 3/02

(52) U.S. Cl. 423/648.1

(57) ABSTRACT

A method of hydrogen production including producing a syngas stream in an SMR and removing CO2 and H2 from the syngas stream in a CO2 removal unit, thereby producing a residue fuel stream is provided. The method also includes blending the residue fuel stream with a make-up fuel stream, thereby producing a blended fuel stream, and heating the blended fuel stream, thereby producing a heated blended fuel stream. The method also includes blending the heated blended fuel stream with a steam stream, thereby producing a raw reformer fuel stream, and introducing the raw reformer fuel stream into a LP reformer, thereby producing a reformer fuel stream. The method also includes combusting the reformer fuel stream to the SMR, thereby producing a flue gas that is essentially free of CO2.

### BACKGROUND

Steam reforming of hydrocarbons is most common method for hydrogen production. Large quantities of CO2 are emitted during the hydrogen production. It is desireable to capture and sequester CO2 to reduce GHG emissions. For complete CO2 capture, CO2 has to be removed from the process gas as well as from the flue gas. It is challenging to recover CO2 from the flue gas due to several factors, such as flue gas being at atmospheric pressure, it contains O2 and NOx, it is hot at about 300F, and CO2 concentration is low. The novel process described below eliminates the need for CO2 removal from the flue gas.

### SUMMARY

The present invention is a method of hydrogen production including producing an LP syngas stream using a residue fuel stream (PSA Tailgas) as feedtock in an SMR and removing CO2 and H2 from said LP syngas stream in a CO2 removal unit, thereby producing a residue fuel stream, rich in H2 and low in carbon. The present invention also includes blending said residue fuel stream with a make-up fuel stream, thereby producing a blended fuel stream, and heating said blended fuel stream, thereby producing a heated blended fuel stream. The present invention also includes blending said heated blended fuel stream with a steam stream, thereby producing a raw reformer fuel stream, and introducing said raw reformer fuel stream into a LP reformer, thereby producing a hot crude syngas stream, which is introduced into one or two stages of CO shift section, thereby producing shifted stream The CO2 in the CO shifted stream is removed in a scrubber, forming reformer fuel stream The present invention also includes combusting said reformer fuel stream to said SMR, thereby producing a flue gas that is essentially free of CO2.

### BRIEF DESCRIPTION OF THE FIGURES

FIG. 1 is a schematic representation of one embodiment of the present invention.

### DESCRIPTION OF PREFERRED EMBODIMENTS

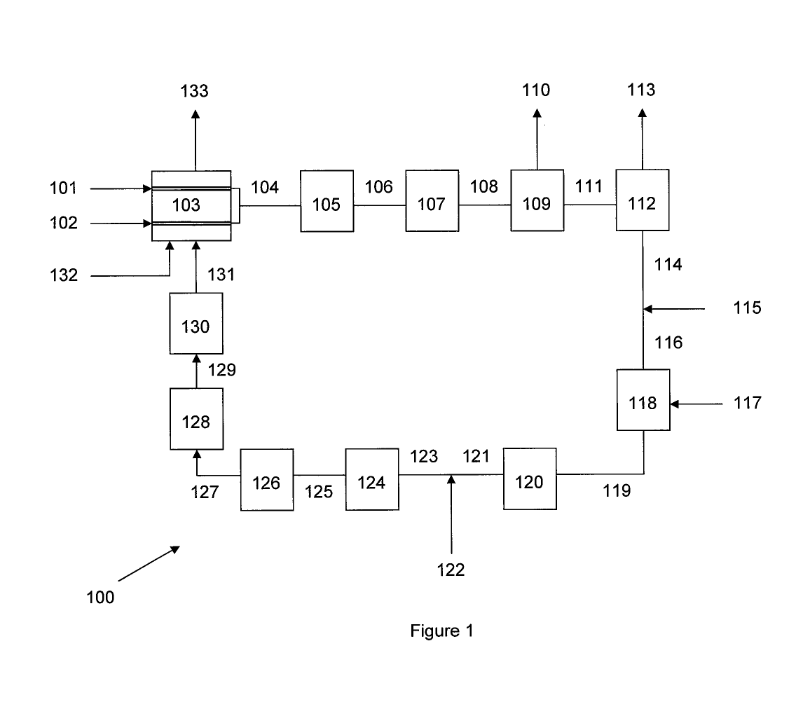

Turning now to FIG. 1, system 100 is presented. Reformer feed stream 101 and reformer steam stream 102 are introduced into the catalyst tubes of reformer unit 103. Reformer unit 103 may be a Steam Methane Reformer (SMR) or an Autothermal Reformer (ATR). Reformer fuel stream 131 (discussed below) is introduced, with combustion oxidant stream 132, into the shell side of reformer 103, where they are combusted thereby providing the temperature and heat required for the reforming process. The products of this combustion exits the shell side of reformer 103 as essentially CO2 free flue gas stream 133. For combustion of H2 rich fuel in reformer 103, burners must be designed accordingly. Staged air burners are good for controlling the flame temperature.

Reformer feed stream 101 is converted into syngas stream 104, which exits reformer 103 and is introduced into high temperature CO shift section 105, thereby producing HT shifted stream 106. HT shifted stream 106 is then (optionally) introduced into low temperature CO shift section 107, thereby producing LT shifted stream 108.

LT shifted stream 108 is then introduced into CO2 scrubber section 109, thereby producing essentially pure CO2 stream 110 and CO2 depleted yngas stream 111. CO2 scrubber section 109 may use a solvent such as amine, Selexol, or hot potassium carbonate solution. It is not necessary to remove CO2 completely from second shifted stream 108. The CO2 removal can be optimized for minimizing the energy required for CO2 removal.

CO2 depleted syngas stream 111 is then introduced into separation means 112 where it is separated into hydrogen stream 113, and residue fuel stream 114. Separation means 112 may be a pressure swing adsorber, a membrane-type separator, or a cryogenic-type separator. Residue fuel stream 114 may contain unconverted CH4, CO, and unrecovered H2 and CO2.

If separation means 112 is a pressure swing adsorber, then residue fuel stream 114 will be the PSA tailgas stream. This tail gas stream 114 will be kept at as low a pressure as possible, typically between about 25 psig and about 35 psig. In one embodiment, the tail gas can be compressed mechanically (compressor not shown) form an even lower desired pressure of between about 3 psig and about 5 psig.

Residue fuel stream 114 is then blended with make-up fuel stream 115, thereby resulting in blended fuel stream 116. Make-up fuel stream 115 may be natural gas, or any other suitable and available hydrocarbon fuel. Make-up fuel stream 115 should be desulfurized. Blended fuel stream 116 is then (optionally) introduced into saturator 118, where it is saturated with process condensate stream 117, thereby resulting in saturated blended fuel stream 119. Process condensate steam 117 may come from different locations within the process. Saturator 118 is heated by low level heat in the syngas or flue gas.

Saturated blended fuel stream 119 is then introduced into preheater 120, thereby producing heated fuel stream 121. Preheater 120 may heat heated fuel stream 121 to a temperature between about 500 F and about 1200 F.

Heated fuel stream 121 is then blended with steam stream 122, thereby producing LP reformer feed stream 123. This blending with steam is done to bring the carbon molar ratio in the range of about 2.0 to about 4.0 The optimum steam to carbon ratio is in the range of about 2.0 to about 2.8. LP reformer feed stream 123 is then introduced into LP reformer 124, thereby producing reformed feed stream 125. Steam stream 122 may also be generated at a desirable low pressure using the low level heat in the syngas or flue gas streams.

LP reformer feed stream 123 is reformed over a catalyst in LP reformer 124. LP reformer 124 utilizes heat from the flue gas. The desired reforming temperature is in the range of about 1300 F to about 1500 F. Reformed feed stream 125 may be cooled in heat exchanger 126, thereby producing cooled raw reformer fuel stream 127. Cooled raw reformer fuel stream 127 may then be introduced to LP shift reactor 128 to convert CO to CO2 and H2, thereby producing shifted raw reformer fuel stream 129.

LP shift reactor 128 may use Fe based or Cu based catalyst, or any other catalyst known to the skilled artisan. The specific reactor conditions will be determined by the selected catalyst.

The CO2 from shifted raw reformer fuel stream may be removed in CO2 removal unit 130, thereby producing reformer fuel stream 131, before it is sent to reformer 103 as fuel. Reformer fuel stream 131 will be mostly free of carbon (it may have a small residual amount of CH4 and CO), and thus flue gas stream 133 will mostly consist of N2 and water.

The CO2 removal from the LP reformer gas may be done in conjunction with the CO2 removal from the syngas. An additional LP CO2 absorber (not shown) may be used with a common CO2 regenerator. CO2 removal may be done at elevated temperatures, such elevated temperatures may be between about 500 F and 1000 F, by using adsorbents such as MgO, CaO, K2CO3, Lithium Silciate based adsorbent, and other such high temperature adsorbents. The CO2 removal at elevated temperatures provide a fuel stream to reformer 103 at high temperatures, thus improving the overall efficiency.

Autothermal reforming or partial oxidation may be used instead of LP reforming. Air is the preferred media for autothermal reforming, though oxygen or enriched air may also be used.

Ejectors (not shown) may be used to raise the pressure of reformer fuel stream 131. Make-up fuel at higher pressure, and steam at higher pressure, may be the motive forces for the ejector. The use of such ejectors will minimize the tail gas pressure which is desirable for increasing the H2 recover of the pressure swing adsorber

Any means known to the skilled artisan may be used to integrate heat recovery from the reformed syngas, LP reformed fuel stream, reformer flue gas, and shifted gas. The heat may be utilized for heating process streams, generating steam, and for supplying heat for prereforming and LP reforming. LP reforming may also be performed in a separate furnace that is independently fired.

What is claimed is:

1. A method of hydrogen production comprising:
producing a syngas stream in an SMR,
removing CO2 from said syngas in a CO2 removal unit, thereby producing a CO2 depleted syngas stream
removing H2 from said CO2 depleted syngas stream in a syngas PSA unit, thereby producing a residue fuel stream,
blending said residue fuel stream with a make-up fuel stream, thereby producing a blended fuel stream,
heating said blended fuel stream, thereby producing a heated blended fuel stream,
blending said heated blended fuel stream with a steam stream, thereby producing a LP reformer feed stream,
introducing said LP reformer feed stream into a LP reformer, thereby producing a reformed fuel stream
removing CO2 from said reformed fuel stream in a fuel gas PSA unit, thereby producing a reformer fuel stream, and
combusting said reformer fuel stream to said SMR, thereby producing a flue gas that is essentially free of CO2.

2. The method of claim 1, further comprising performing a high temperature CO shift, thereby producing a HT shifted syngas stream, and introducing said HT shifted syngas stream into said CO2 removal unit.

3. The method of claim 2, further comprising performing a low temperature CO shift, after said high temperature CO shift, thereby producing a LT shifted syngas stream, and introducing said LT shifted syngas stream into said CO2 removal unit.

4. The method of claim 1, wherein said CO2 removal unit utilizes a solvent system, wherein said solvent is selected from the group consisting of amine, Selexol, and hot potassium carbonate solution.

5. The method of claim 1, wherein said tail gas stream has a pressure of between about 25 psig and about 35 psig.

6. The method of claim 1, wherein said residue fuel stream has a pressure of between about 3 psig and about 5 psig.

7. The method of claim 6, further comprising a tail gas compressor.

8. The method of claim 1, wherein said heated blended fuel stream has a temperature between about 500 F and about 1200 F.

9. The method of claim 1, wherein said reformer fuel stream has a steam to carbon molar ratio, wherein said steam to carbon molar ratio is between about 1.5 and about 4.0.

10. The method of claim 9, wherein said steam to carbon molar ratio is between about 1.8 and about 2.8.

11. The method of claim 1, wherein said LP reformer operates at a temperature of between about 1300 F and about 1500 F.

12. The method of claim 1, wherein said LP shift utilizes catalysts, wherein said catalyst are Fe based.

13. The method of claim 1, wherein said LP shift utilizes catalysts, wherein said catalyst are Cu based.

14. The method of claim 1, wherein said LP reformer utilizes catalytic autothermal reforming.

15. The method of claim 14, wherein said catalytic autothermal reforming utilizes air as oxidant.

16. The method of claim 14, wherein said catalytic autothermal reforming utilizes pure oxygen or oxygen enriched air as oxidant.

17. The method of claim 1, wherein said LP reformer utilizes non-catalytic partial oxidation reforming.

18. The method of claim 17, wherein said partial oxidation reforming utilizes air as oxidant.

19. The method of claim 17, wherein said partial oxidation reforming utilizes pure oxygen or oxygen enriched air as oxidant.

20. The method of claim 1, wherein said syngas PSA unit and said fuel gas PSA unit are the same unit.
